(19) United States
(12) Patent Application Publication
(10) Pub. No.: US 2013/0111483 A1
(43) Pub. Date: May 2, 2013

(54) AUTHORING AND USING PERSONALIZED WORKFLOWS

(71) Applicants: Natasa Milic-Frayling, Cambridge (GB); Jamie Costello, Hertfordshire (GB); Peiwen Li, New York, NY (US)

(72) Inventors: Natasa Milic-Frayling, Cambridge (GB); Jamie Costello, Hertfordshire (GB); Peiwen Li, New York, NY (US)

(73) Assignee: MICROSOFT CORPORATION, Redmond, WA (US)

(21) Appl. No.: 13/284,981

(22) Filed: Oct. 31, 2011

(51) Int. Cl. G06F 9/46

(52) U.S. Cl. 718/102

(57) ABSTRACT

A workflow authoring system receives a request from a user identifying a task, wherein the task includes various task components. The system selects a plurality of services in response to the user's request to generate one or more service options. The workflow authoring system identifies one or more parameters associated with the selected services and maps one or more relationships between the identified parameters. Mapping the relationships between the identified parameters includes normalizing the identified parameters across one or more services and/or determining dependencies between the identified parameters. The workflow authoring system determines parameter values for the identified parameters satisfying the one or more relationships and determines one or more service options and workflows related to the service options based on the determined parameter values.

### BACKGROUND

Modern computing and communication technology and the growth of the Internet allow provision of various services to end users through a wide variety of devices, such as desktop computers, laptops, personal data assistants, cell phones, smart phones, etc. Examples of services available through such devices include travel planning, entertainment and meal planning, shopping, online banking, mapping, etc. For example, there are dedicated websites that allow users to book flights and make hotel reservations. Other dedicated websites allow users to manage their money, banking, credit cards, etc. Similarly, users can access websites to plan a vacation, with one website providing maps, another website providing hotel reservations, a third website providing restaurant reservations, etc.

Recent trends suggest that an increasing number of users access such services via mobile devices, such as smart phones. Specifically, with the increase in the computing capabilities of smart phones and with the increase in the reliability and speed of wireless networks, more services previously accessible through Internet websites are now available through applications provided on smart phones. Additionally, smart phones are also equipped with features that provide additional information, such as geographical positioning system (GPS) information, a user's personal information, a user's preferences, etc., that are utilized by such services.

However, users are frequently unaware of most of the available online services and often users do not have any way to determine which services are more suitable than others for completing a given task. Moreover, the services (or applications) provided to the users, either via the Internet websites or via smart phone applications, are not integrated with each other. For example, when a user wants to plan an event or an itinerary that may involve a large number of task components, such as searching destinations, planning directions, making reservations, etc., the user has to personally access each service, manually provide input information to each service and coordinate the inputs and outputs related to each service individually. Given that the various services are designed separately, coordinating the workflow and information among such services becomes challenging and time consuming.

### SUMMARY

Implementations described and claimed herein address the foregoing problems by providing a personalized workflow authoring system. The workflow authoring system receives a request from a user identifying a task with several task components. Alternatively, the system builds the task workflow incrementally as the user specifies the task components. The system selects services (e.g., remote services and local device applications) in response to the user's request for the task or task components to identify service options for completing the task or task components. The workflow authoring system also identifies parameters associated with the selected services and maps relationships between the identified parameters of the services. In one implementation, mapping the relationships between the identified parameters includes normalizing the identified parameters across the services and/or determining dependencies between the identified parameters. The workflow authoring system determines parameter values for the identified parameters satisfying the relationships and determines the service options based on the determined parameter values. The services and the determined values of the identified parameters are used to present the options to the user and/or automatically execute the options to generate workflows. In one implementation, the workflow authoring system selects the services, determines the parameter values, and generates the workflows subject to a constraint provided by the user and/or subject to an optimization request provided by the user. In another implementation, the user selects an existing task workflow and identifies the task components of the selected workflow that are to be used in a new workflow. In yet another implementation, the system recommends a multiplicity of workflows for a given task request, and the user pick and choose the task components from multiple workflows to be used in a new workflow.

In some implementations, articles of manufacture are provided as computer program products. One implementation of a computer program product provides a tangible computer program storage medium readable by a computing system and encoding a processor-executable program. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates example data sources and flows for a personalized workflow authoring system.

FIG. 2 illustrates alternate example data sources and flows for a personalized workflow authoring system.

FIG. 3 illustrates example operations for authoring a personalized workflow.

FIG. 4 illustrates example operations for using a personalized workflow.

FIG. 5 illustrates an example network for implementing the architecture for authoring and using personalized workflows.

FIG. 6 illustrates an example system that may be useful in implementing the described technology.

FIG. 7 illustrates another example system (labeled as a mobile device 700) that may be useful in implementing the described technology.

### DETAILED DESCRIPTION

In various implementations, a workflow authoring system operates as a remote service, a local service, a stand-alone application, or some combination thereof. The workflow authoring system receives a request from a user identifying a multiple-component task, wherein the task includes several task components involving one or more services. For example, a user-identified task can be directed to planning an evening dinner and movie with a friend, and the components of such a task can include selecting a restaurant, making a reservation, selecting a movie, buying movie tickets, etc. The system selects service options, such as an online restaurant reservation service, online ticket purchase service, etc., in response to the user's request and combines them into a workflow for completing the task. Workflows can be persisted within the system, so that the user can re-execute the workflow, revise the workflow, and/or combine components of different workflows to create a new workflow.

The workflow authoring system also identifies various parameters associated with the selected service options and maps relationships between the identified parameters. For example, the system identifies the time of dinner as an input parameter for the online reservation service and the time of the movie as an input parameter for the online ticket purchase service. In one implementation, mapping the relationships between the identified parameters includes normalizing the identified parameters, such as the time for dinner and the time for movie, across the service options and/or determining dependencies between the identified parameters. The workflow authoring system determines parameter values for the identified parameters satisfying these relationships and determines the service options, and the workflows related to the service options, based on the determined parameter values. Thus, an example service option offers a movie ticket service for seeing a movie before dinner whereas an alternative service option offers a concert after a dinner.

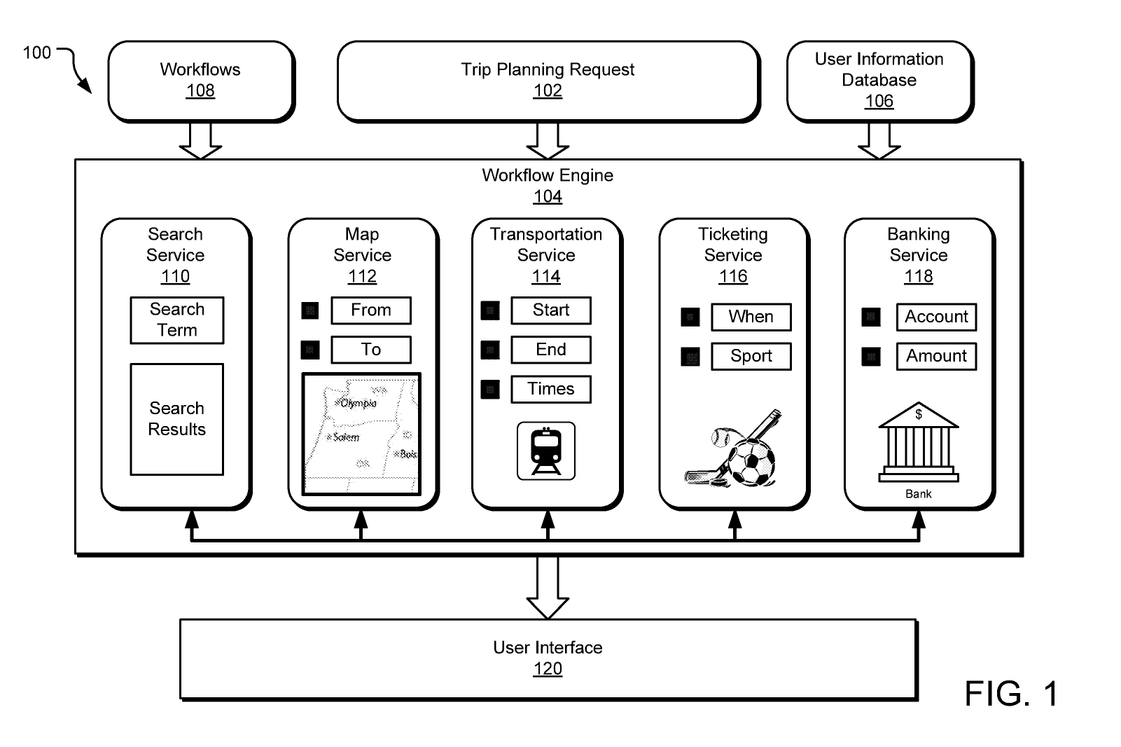

FIG. 1 illustrates example data sources and flows 100 for a personalized workflow authoring system. As illustrated in FIG. 1, a user submits a trip planning request 102 to a workflow engine 104. For example, the trip planning request 102 identifies the task of generating an itinerary for a user's trip subject to several constraints. In this example, the trip planning request 102 indicates the task of trip planning that the user wishes to accomplish. Such a task may include several task-components. Furthermore, a task and a task-components may involve various services. A workflow may comprise the task components, relationship among such task components, and the global and local optimization of the task-components. An implementation of the workflow authoring system disclosed herein includes a number of actions including selection of component services to facilitate the completion of a task-component, composition of services based on parameter normalization, optimization of the composite services based on the task objectives, etc. In an implementation, the selection of services is done based on previous workflows from the user or other sources, search over new services, etc. In an alternative implementation, the workflow authoring system passes parameters across services and automatically refines the workflow.

An example trip planning request 102 is a request for planning a trip to a particular city to see a baseball game. Such a trip planning request 102 includes various tasks components, such as searching available tickets for the game, making a ticket purchase, planning transportation to the game, etc. As part of such a trip planning request 102, the user provides information about which baseball game the user wants to attend. For example, a user living in Seattle asks the workflow engine 104 to plan a trip to go see a Seattle Mariners' home game. The trip planning request 102 also provides additional information about the date of the game, preferred seating, etc.

The workflow engine 104 receives the trip planning request 102 from the user and generates itinerary service options for the user. The workflow engine 104 analyzes the trip planning request 102 to determine the task identified by the request as well as to identify task components. Based on the determination of the task components, the service engine selects services or applications that can be used to generate service options for the user's itinerary. In one implementation, the workflow engine 104 selects the services for generating service options based on a set of workflows 108. The workflows 108 include a number of pre-existing workflows that are developed and used by the workflow engine 104 in response to various user requests. In one implementation, the workflows 108 are stored on a datastore that can be distributed and accessed form a number of different locations. Alternatively, such a workflow datastore can be centrally located on a server. The workflow engine 104 uses a particular workflow from the workflows 108 based on analysis of the trip planning request 102. In the present example, the workflow engine 104 analyzes the trip planning request 102 to determine that the workflow engine 104 will use workflows related to a trip to a baseball game. One example workflow for a trip to a baseball game provides a series of services for the component tasks of the trip planning request.

In an alternate implementation, the workflow engine 104 selects the services from a collection of preferred services or based on a search. The workflow engine 104 undertakes such a search for services using a search service 110. An example, of a search service 110 is an application search service that searches for applications, also known as “Apps,” based on the component tasks of the trip planning request 102. Alternatively, the workflow engine 104 accesses and searches a listing or database of services to identify the services that can be used to plan the trip as requested by the trip planning request 102. In one implementation, the workflow engine 104 uses a collection of predetermined workflows that can be used to determine an itinerary based on a request from a user. For example, the workflow engine 104 stores a set of workflows and categorizes the saved workflows so that a request from a user can be matched to one of these workflows. The selected workflow provides information about services that are to be used for various task components of the user's request.

The workflow engine 104 also determines which services to use based on information about the user, such as the user's location, the user's ticket purchases in the past, etc. The workflow engine 104 accesses such user specific information from a user information database 106. The user information database 106 stores information about users such as the users' preferences, the users' past usage, etc. If external pieces of information are needed, the workflow engine 104 selects such information based in the context of the trip planning request 102 and in the context of information about the user, such as the user's preferences, user's profile, etc.

In one example, the workflow engine 104 determines that in the past, the user has always used public transportation, such as a train system, to attend baseball games. In such a case, to determine information about how the user can access a train system, the workflow engine 104 first determines information about the originating location where the user is starting the trip and the destination location. In one example, to determine the originating location, the workflow engine 104 uses the current location of the user. Such information about the user's current location can be accessed from the global positioning system (GPS) parameters provided by the user's mobile phone, although other locating methods may be employed (e.g., triangulation from cell towers, manual input of address, etc.). Subsequently, the workflow engine 104 determines the location of the user's destination, the baseball stadium. The Service engine determines the location of the baseball stadium by accessing a search service (not shown), such as the Bing® service.

After determining the origination and the destination locations, the workflow engine 104 selects and interacts with a map service 112 using such location information to plan the trip. For example, the workflow engine 104 selects a map service 112 that provides most detailed information at the user's location. The workflow engine 104 also determines other services that can be used in order to plan itineraries based on the trip planning request 102, such as a transportation service 114, a ticketing service 116, etc. Subsequently, the workflow engine 104 uses the information about the user to determine which particular transportation service 114 to use. For example, based on the information that the user has used public transportation in the past, the workflow engine 104 determines using a service provided by the Seattle Public Transit as the transportation service 114. While the implementation discussed above discusses selection of service in view of the origination and destination location, in alternative implementations, other parameters, such as the time of service, the social contacts of the users, etc., can also be used to select services.

After determining which service to use as the transportation service 114, the workflow engine 104 analyzes the application programming interface (API) of the transportation service 114 to determine how to communicate with the transportation service 114, the input parameters used by the transportation service 114, which input parameters are mandatory, what are the output parameters generated by the transportation service 114, etc. Examples of input parameters include a starting location, an ending location, a time of travel, etc. Examples of output parameters include a schedule for the train, current delays on the train system, etc. If the workflow engine 104 has already used the transportation service 114, the workflow engine 104 may have stored such information about the API parameters of the transportation service 114. In such a case, the workflow engine 104 does not have to access the transportation service 114 to collect such information.

Given that the trip planning request 102 includes the task of planning itinerary for a trip to Seattle Mariners' baseball game, the workflow engine 104 communicates with a ticketing service 116 to determine the game time, the cost of ticket, the availability of tickets, etc. By communicating with the ticketing service 116, the workflow engine 104 determines the API framework of the ticketing service 116, such as the input parameters that are needed to receive service from the ticketing service 116, etc. By communicating with the ticketing service 116, the workflow engine 104 determines that the seating preferences of the user, the amount of money the user wants to spend for the game, etc., are used as the input parameters for completing a task component using the ticketing service 116. The workflow engine 104 also determines the output parameters of the ticketing service 116, such as the time of various games for which tickets are still available, the cost of various available tickets, etc. The workflow engine 104 collects and stores such information about the input and output parameters of the ticketing service 116.

Furthermore, based on the workflow selected in response to the trip planning request and/or based on the user information, the workflow engine 104 also selects a banking service 118 for generating a user itinerary. The banking service 118 provides financial information about the user providing the trip planning request 102. For example, the banking service 118 provides the credit card information, the amount of credit available, the debit card information, the user's bank account number, the amount of money available for planning the requested trip, etc. For example, after analyzing the service profile of the user, the workflow engine 104 determines that the user prefers using a particular credit card that maximizes privileges for the user, such as frequent flyer mileage. In such a case, the workflow engine 104 uses that particular credit card in completing transactions as necessary.

The workflow engine 104 also collects additional information about the user based on past user information accessible to the workflow engine 104. Such past user information can be accessed, for example, from the user information database 106. For example, such information includes the user's preferences, information about past outings to baseball games, information about the user's social network, etc. In one example, in selecting the seats for the user, the workflow engine 104 also searches if any of the user's acquaintances are also attending the game and if so whether the seating can be selected based on such information. The workflow engine 104 determines such information about the user's acquaintances based on the relations of the user in the user information database 106. In one implementation, the workflow engine 104 searches for and uses such user information only if the service engine has appropriate prior approval from the user to do so.

Even though the workflow engine 104 is described above as accessing various services 110-118 sequentially, in practice the workflow engine 104 can access each of these services simultaneously. As a result, the workflow engine 104 analyzes the APIs for the services 110-118 and determines the input and output parameters of the services in parallel. Furthermore, the workflow engine 104 can also communicate with various services simultaneously where each of these services can be used to complete a single task component. For example, to determine itineraries in response to the trip planning request 102, the workflow engine 104 communicates with a ticketing service 116 provided by the Seattle Mariners and a ticketing service 116 provided by an online ticketing agency, such as the Ticketmaster® service. In such a case, the workflow engine 104 is able to compare the APIs and various parameters of each of these ticketing services 116 to provide more than one itinerary options in the user interface 120 to the user. Furthermore, in such a case, the workflow engine 104 is also able to evaluate the parameters of different ticketing services 116 in the context of the parameters of other services 110, 112,114, and 118. For example, if the banking service 118 suggests that the amount of money that the user can spend on the tickets is limited, the tickets available from the Ticketmaster® service is the one that is selected, even if the seats available through the Ticketmaster® service are less desirable. Alternatively, if the analysis of the privacy parameters of the Ticketmaster® service suggests that there is more privacy risk to the user's data when using the Ticketmaster® service, the workflow engine 104 determines using the ticketing service 116 provided by the Seattle Mariners.

Subsequently, the workflow engine 104 identifies and analyzes the input and output parameters collected from the various services 110-118 to determine if the workflow engine 104 needs to access any of the services again to get any additional information. For example, after reviewing parameters received from the ticketing service 116, the workflow engine 104 finds that the ticketing service 116 will not accept a particular credit card that is preferred by the user. In another example, the ticketing service 116 provides additional discount if an online payment service, such as the Paypal® service is used to make a payment. In such a case, the workflow engine 104 communicates with such an alternate online payment service (not shown) to determine information necessary to complete the itinerary planning The workflow engine 104 also identifies relationships between the parameters of the various services 110-118. An example of such relationship is the dependency between the identified parameters. For example, the workflow engine 104 determines that the amount of money available to a user, an output parameter of the banking service 118, needs to be determined before completing a task component using the ticketing service 116.

Once the workflow engine 104 has communicated with the services 110-118, the workflow engine 104 analyzes the information collected from these services 110-118 to determine parameter values for the identified parameters. The workflow engine 104 generates these parameter values such that relationships between the identified parameters are satisfied. Subsequently, the workflow engine 104 generates service options for the workflow user interface 120 using the determined parameter values. For example, based on the time of the baseball game, the cost of the ticket to the game, the money available to the user, and the user's location, and the user's commuting preferences, the workflow engine 104 generates two alternative itineraries for a trip to the baseball game. A first itinerary includes the user taking the train from a train station closest to the user's current location and tickets for box seats at the game. On the other hand a second itinerary includes a taxicab ride from the user's current location and tickets for bleacher seats at the baseball game. Note that to generate information about the second itinerary, the workflow engine 104 has already communicated with an alternate transportation service 114 that provides information about the cost and availability of taxicab for transportation to the game.

Based on the user's preference, the service options are presented to the user on the user interface, such as a user's smart phone, tablet device, laptop, etc. In one example, the user interface 120 can present menus that allow the user to combine choices from the service options. In a more detailed example, for a trip to a baseball game, the user is able to use a drop-down menu to select the seating option from the first itinerary and the transportation option from the second itinerary. Alternatively, the user selects one of the service options as provided by the workflow engine 104. Based on the user's selection of one of the service options, the workflow engine 104 communicates with the services 110-118 to complete various task components. Thus, if the user has selected seating for the baseball game that is available through the ticketing service 116 provided by the Seattle Mariners, the workflow engine 104 communicates with such ticketing service 116 to complete the task component of ticket purchase.

Similarly, if the user selects a taxicab service as the transportation choice, the workflow engine 104 communicates with the transportation service 114 providing taxicab services to make a reservation for the taxicab. In such a case, because the workflow engine 104 already has access to information about the time of the game, the user's location, the user's credit card information, etc., based on the user's preference, the workflow engine 104 can communicate with such transportation service 114 to complete the taxicab reservation.

In one example, the trip planning request 102 also includes optimization criteria and constraints provided by the user. For example, the trip planning request 102 specifies that the cost of the entire trip to the baseball game should not exceed one hundred dollars. In such a case, the workflow engine 104 ensures that each of the service options complies with such a constraint. Another example of the trip planning request 102 specifies that the workflow engine 104 select trips that will minimize the carbon footprint. Based on the user's optimization requests and constraints, the workflow engine 104 ranks the service options presented to the user. Such ranking can also be generated without the user providing any request to do so. For example, if the workflow engine 104 determines that, based on the user's profile, it is important for the user to reduce carbon emissions, the workflow engine 104 automatically ranks the service options based on carbon emissions generated as a result of each itinerary.

In one implementation, based on the analysis of the information collected from the various services 110-118, the workflow engine 104 determines that one or two of the parameters are commonly used across the services 110-118. For example, the workflow engine 104 determines that each of the ticketing service 116 and the banking service 118 uses the identity information such as the first name and the last name of the user. The ticketing service 116 uses the user identity information to issue ticket, whereas the banking service 118 uses user identity information to access a credit card account. In such a case, the workflow engine 104 uses a normalized parameter value for the identify information that is used for communicating with both the ticketing service 116 and the banking service 118. In one example implementation, the workflow engine 104 iterates through the services 110-118 to generate the service options.

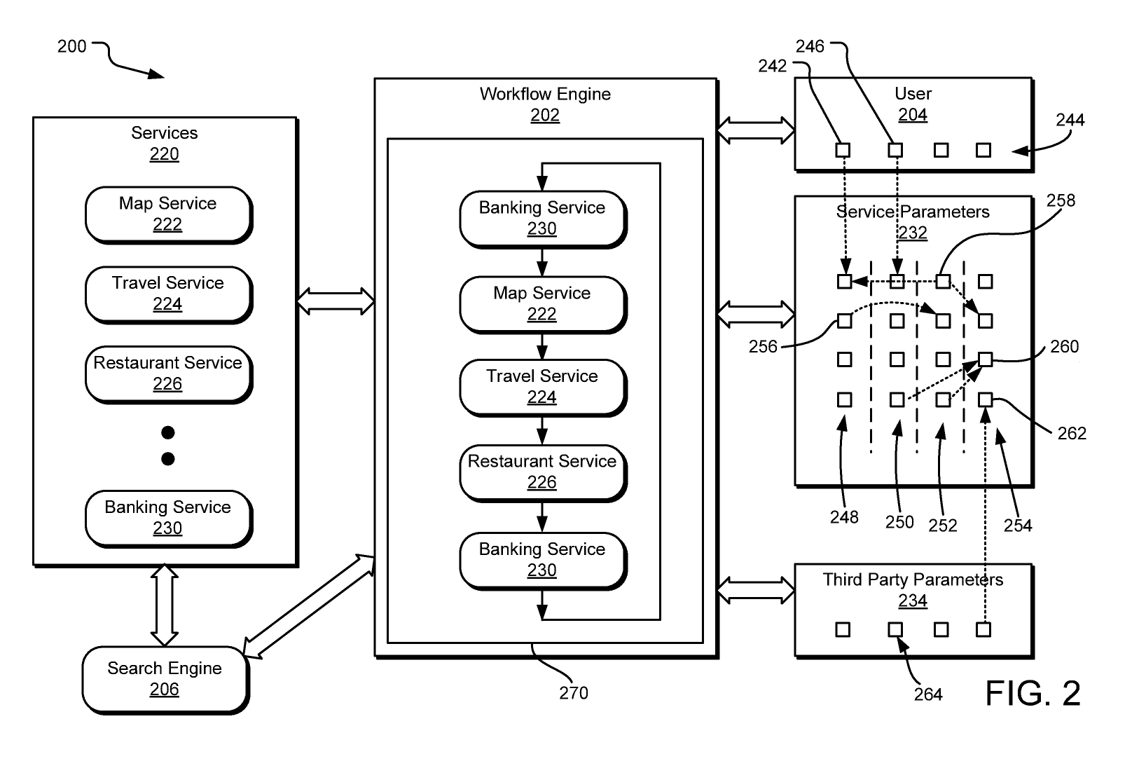

FIG. 2 illustrates alternate example data sources and flows for a personalized workflow authoring system 200. The personalized workflow authoring system 200 is illustrated here as including a workflow engine 202 that assists a user 204 in planning a vacation. Specifically, the data sources and the flows of the personalized workflow authoring system 200 are illustrated here in the context of a request by the user 204 for the task of planning a one day trip to a city within fifty miles of the user's location. As part of the request, the user additionally specifies task components, including having a dinner at an Italian restaurant in the destination city and spending no more than the amount of money that the user has in her bank account above one thousand dollars. The user 204 provides the request to the workflow engine 202 using one of a simple text instruction, a graphical user interface (GUI) that allows the user to specify task components of his request, etc. Alternatively, verbal instructions are used to provide the request and a voice recognition engine interprets such a request.

The workflow engine 202 uses services or applications (collectively, “services 220”) to generate service options. In one implementation, the services 220 used by the workflow engine 202 includes a number of mobile applications provided on smart phones, such as iPhone® applications, Android® applications, etc. Alternatively, the workflow engine 202 also uses online services provided by various service providers, such as an Expedia® service, etc. Depending on the complexity of the request submitted by the user 204, the workflow engine 202 can also use a combination of mobile applications and online services. Furthermore, even if the user 204 is using a particular type of smart phone, the services 220 used by the workflow engine 202 is not restricted to applications available to that particular smart phone.

In one example, the user 204 selects the services 220 that will be used by the workflow engine 202. For example, the user may drag and drop such services into a specialized GUI. Alternatively, the workflow engine 202 uses existing services that the user 204 has used in the past. If the workflow engine 202 determines that additional services are needed in order to assist the user's request, the workflow engine 202 uses a search engine 206 to search for such additional services. In one implementation, the workflow engine 202 uses the search engine 206 at different stages through its building of a workflow in response to the request from the user 204. For example, for the one day trip request from the user 204, once the workflow engine 202 determines a destination city, the workflow engine 202 uses the search engine 206 to determine the optimal service for searching restaurants in such destination city. The workflow engine 202 uses various criteria to make such a service selection. An example criterion is to select a service that will provide the highest number of choices for Italian restaurants in the destination city. Alternatively, a service that is most popular with the social network of the user 204 is selected. In the example illustrated in FIG. 2, the workflow engine 202 determines using a map service 222, a travel service 224, a restaurant service 226, and a banking service 230 to generate service options based on the request from the user 204.

Once the workflow engine 202 receives the request and determines the services 220 that will be used in building a workflow, the workflow engine 202 communicates with the services 220 to determine the API of these services. Subsequently, the service engine 202 determines service parameters 232 for the selected services 220. For the example illustrated in FIG. 2, the service parameters 232 include map service parameters 248, the bank service parameters 250, the travel service parameters 252, and the restaurant service parameters 254. The workflow engine 202 determines such parameters based on the past usage of the selected services 220, by communicating with the selected services 220, etc. For example, if the workflow engine 202 has used the map service 222 in the past, the workflow engine 202 determines that in order to get information about the cities within one hundred miles of the user 204, the workflow engine 202 requires the location of the user 204. The workflow engine 202 determines the location of the user based on a location parameter 242 from the profile of the user 204. The location parameter 242 is an example of the user parameters 244 used by the workflow engine 202. As illustrated in FIG. 2, the workflow engine 202 uses the location parameter 242 as an input parameter for the map service parameters 248.

Another example of a service used by the workflow engine 202 is the banking service 230. Based on the request provided by the user 204, the workflow engine 202 determines to access the banking service 230 in order to determine the balance in the user's bank account. The workflow engine 202 communicates with the banking service 230 to determine bank service parameters 250 needed to use the banking service 230. An example of such a parameter is a bank account number 246 of the user 204. The workflow engine 202 has access to the bank account number 246 as part of profile information about the user 204. The workflow engine 202 uses the bank account number 246 as an input parameter for the banking service parameters 250.

Once the workflow engine 202 has determined the service parameters 232, the workflow engine 202 determines relations between these parameters. Such relationships include dependencies between the parameters, the limitations imposed by one of the service parameters 232 on the other service parameters 232, joint constraints on the values of the service parameters 232, etc. An example of such a relation is a dependency relation between one of the map service parameters 248 and one of the travel service parameters 252, wherein a map service parameter 248, such as a location of the user 204 has be determined first before a travel service parameter 252, such as a cost of travel to a destination city is determined. Another example of such a relation is a relation between a travel service parameter 252 such as the cost of travel and a restaurant service parameter 254 such as the cost of dinner, which specifies that the total of the values for each of these two parameters is equal to or less than a specified amount. Based on the determination of such relationships between various service parameters 232, the workflow engine 202 determines values of these parameters. Subsequently, the workflow engine 202 generates service options using the determined parameter values and generates workflows that provide an order in which the services 220 are selected and executed.

In the case of the user's one day trip request discussed above, the workflow engine 202 selects the banking service 230 as the first service in the workflow. This is due to a constraint imposed by the user's request. In executing the banking service 230, the workflow engine 202 uses the user's bank account number 246, the user's password (not shown), etc. If the password is saved on a user profile, or in a cookie on a user device, the workflow engine 202 fetches such password. Alternatively, the workflow engine 202 sends a message to the user to provide such password. Once the workflow engine 202 has identified parameter values for executing the banking service 230, the workflow engine 202 determines the budgeted dollar amount to plan the one day trip. For example, if the user has $1550 in the bank account, the workflow engine 202 determines that the cost of the one day trip should not be more than $550.

Subsequently, the workflow engine 202 evaluates a map service 222 to determine the location of the user 204 and the list of potential travel destinations within the range specified by the user 204. The workflow engine 202 determines a number of the map service parameters 248 for executing the map service 222. One such parameter is the current location 242 of the user 204, which can be derived from the user parameters 244. The output parameters generated by the map service 222 are, for example, locations of cities parameter 256 within the one hundred mile distance from the location of the user 204. The workflow engine 202 saves the locations of the cities parameter 256 for use by the travel service 224. Thus, the locations of cities parameter 256 become an input parameter for the travel service 224. The workflow engine 202 stores values of the travel service parameters 252. One such travel service parameter 252 is the name of the destination city 258. Furthermore, the name of the destination city 258 is also provided to the map service 222 so that the map service 222 can map the direction to the destination city, the locations of and the directions to various attractions in the destination city, the locations of and the directions to various restaurants in the destination city, etc.

Subsequently, the workflow engine 202 communicates with the restaurant service 226 to determine the potential choices for the restaurants for user 204. In making such determination, the workflow engine 202 can use a number of parameters from the other services. For example, the workflow engine 202 uses name of the destination city 258 from the travel service parameters 252, a cost of travel parameter (not shown) from the travel service parameters 252, an available budget parameter (not shown) from the banking service parameters 252, etc. Subsequently, the value of the cost of travel parameter and the value of the available budget parameter are used to determine the available budget for dinner and compared against the value of a cost of dinner parameter 260.

The workflow engine 202 also determines values for one of more of the service parameters 232 using third party parameters 234. Examples of such third party parameters 234 are parameters based on social network of the user 204, parameters related to ranking of various restaurants in the destination city, etc. In the example implementation, one of the restaurant parameters 254 is an online ranking parameter 262. The workflow engine 202 gets the value of the online ranking parameter 262 from the third party parameters 234. Thus, for example, rankings provided by the members of the user's social network, weighted average of such rankings, etc., can be used as an input value for the online ranking parameter 262. The workflow engine 202 also takes into consideration other third party parameters 234 such as available discount coupons 264, etc., in making the selection of the destination city, the recommended restaurant, etc.

Once the workflow engine 202 has determined the destination city, the name of the restaurants, the cost, etc., the workflow engine 202 provides service options for the one day trip plan to the user 204. The user 204 can either accept one of such service options or change parameters of the search. For example, for a user in Denver, a first service option includes a trip to Colorado Springs and dinner at the Sunbird restaurant, whereas a second itinerary includes a trip to Boulder and dinner at the Frasca restaurant. In one implementation, the service option components are provided in a menu format. Thus, the workflow engine 202 provides a list of four different potential restaurants via a drop-down menu and the user 204 selects one of the restaurants to complete the itinerary. The workflow engine 202 also provides a list of variable parameters for the itinerary components. For example, a drop-down button is provided next to the name of the recommended restaurants to provide list of available reservation times and average dinner costs. In one implementation, the workflow engine 202 generates the menu of available choices based on the constraints provided by the user 204. As a result, the user 204 can select any of the menu choices and still the total cost of the itinerary will not go over the budget provided by the user 204.

In an alternative implementation, selection of the itinerary choices for the user 204 is accompanied by an advertisement, a coupon, etc. Thus, for example, if the user is recommended a trip a Boulder, a coupon for dessert at a different Boulder restaurant, an advertisement for happy hour at another Boulder restaurant, etc., are displayed alongside the recommended choices. Alternatively, the coupon, the advertisement, etc., are dependent upon selection made by the user.

Once the workflow engine 202 receives an input from the user 204, the workflow engine 202 determines the workflow 270 of the services 220. The workflow 270 illustrates an example implementation of the order in which the services 220 are executed. The workflow 270 illustrates the services 220 to be executed in a sequential order. However, in other implementations, the services 220 are executed in a different order. Furthermore, the services 220 can also be executed more than once. For example, in the implementation illustrated herein, the workflow engine 202 executes the banking service 230 twice, first time to get information about the bank balances and a second time to get information about the debit card or credit card of the user 204. Subsequently (not shown) the restaurant service 226 is executed again to make a reservation at the selected restaurants. Furthermore, in an alternative implementation, the services 220 are executed in parallel, in an iterative loop, etc.

The implementation described in FIG. 2 illustrates generation and execution of the personalized workflow 270 based on the request from the user 204. Such workflow 270 can also be stored for later use by the user 204. In an alternative implementation, the workflow 270 can be shared on the user's social network for future use by other members of the user's social network. In case of such sharing, components of the workflow 270 that include private information, such as banking information, are not shared. In an alternative implementation, the workflow engine 202 uses such an existing workflow as a template to start developing the personalized workflow 270 for the user 204.

In an alternative implementation, the workflow engine 202 creates wrap-around parameters that are used by the services 220. For example, the workflow engine 202 creates a total budget parameter and sets its value based on the output from the banking service 230. Subsequently, the total budget parameter is used during execution of the various other services 220. Similarly, a wrap-around parameter for user's name can also be used across all services, such as, to access user's bank account using the banking service 230, to make reservation using the restaurant service 226, etc. An implementation of the workflow engine 202 also provides parameter normalization and parameter optimization services. Such services enable composition of various services into a workflow and then execution of the workflow including such services. The composition of the various services may include optimization of various parameters based on the user preferences, the user's trust, etc. In one implementation, a second level of optimization is provided during the execution of the workflow. Moreover, if a desired level of optimization is not achieved, the workflow engine 202 allows the user to accept the generated solution or to consider new services. The workflow engine 202 also provides a determination service that determines the relationships between the various parameters.

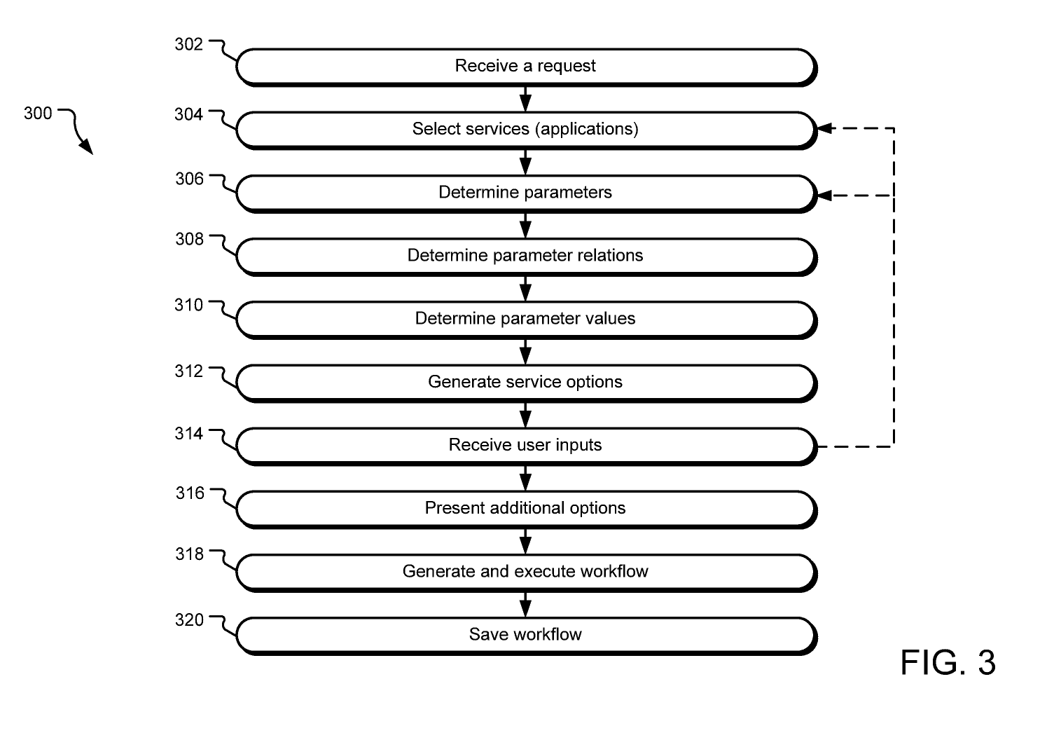

FIG. 3 illustrates example operations 300 for authoring a personalized workflow. A receiving operation 302 receives a request from a user identifying a task, wherein the task includes various task components, user preferences, etc. An example of such a request identifies a task to plan a hiking trip, wherein the user specifies the task as planning a hiking trip and specifies various preferences, such as the day of the trip, the type of hike, number of people, etc. In response to the request, a selection operation 304 selects services or applications related to the task components. For example, in response to receiving a request for a hiking trip, the selection operation 304 selects a map service and a park and recreation service. The selection operation 304 selects the services by using a search engine. Alternatively, the selecting operation selects the services from a predefined group of services or based on service preference of the user.

Subsequently, a determining operation 306 determines the parameters related to the selected services. The determining operation 306 determines the parameters by communicating with the application programming interface (API) of the services. The determining operation 306 determines various characteristics of the parameters, such as whether one of the parameters is a required parameter, an optional parameter, etc. In one implementation, the determining operation 306 determines the parameters by directly communicating with the services. Alternatively, if a particular service is used in the past, the parameters related to that service are already stored in a database that is accessible to the determining operation 306. For example, if a map service is used in the past, determining operation 306 knows the parameters, such as a starting location, a destination, etc., required by the map service. A determination operation 308 determines relationships between the parameters. For example, the determination operation 308 determines that before executing a park and recreation service to find out about various hiking locations, the value of the location of the user parameter has to be determined.

Subsequently, a determination operation 310 determines values of the parameters. For example, the determination operation determines the value of the starting location parameter based on the location of the user. In some cases, determining the parameter values for the selected services includes several iterations. Alternatively, the determination operation 310 determines parameter values based on constraints provided by a user or based on an optimization criterion specified by the user. For example, if the user has specified that the maximum travel distance to the hike is fifty miles, the determination operation 310 selects only those destinations that meet such constraint.

A generation operation 312 generates service options for the user. For example, in response to the request for hiking trip planning, the generation operation 312 provides a list of trip service options to the user. In one implementation, such a list is provided to the user via a menu, wherein the menu includes drop down boxes. A receiving operation 314 receives user inputs related to the selection of the service options. In an alternative implementation (shown in the alternative with dashed arrow lines), after receiving the user inputs by the receiving operation 314, the control is transferred to the selecting operation 304 to further refine the service options presented to the user based on the user input or to determining operation 306 to refine the parameters used in the workflow. Alternatively, the user can select a combination of component service options from the list of service options. For example, the user can select a hiking location from a first service option and a mode of transportation to the hiking location from another service option.

In an implementation, after the receiving operation 314 receives the user inputs, a presenting operation 316 presents the options for other possible task-components to the user. For example, if the user is requesting the service options for a task that involves the task-component of a dinner reservation, the presenting operation 316 provides an option for an additional task-component of a reservation at an after dinner dessert bar to the users. If the user selects such a task-component, it is subsequently incorporated into the workflow.

Subsequently, a generation operation 318 generates and executes a workflow based on the user selections. Thus, based on the user's selection of a particular hike, the generation operation 318 executes a map service to generate directions to the hike from the user's location. Additionally, if the user has specified the date and time of the hike, the generation operation 318 also executes a weather service to get information about the weather conditions for the hike. If it is determined that it is necessary to make a reservation for the hike, the generation operation 318 also executes a parks and recreation service to make such a reservation in the user's name. A saving operation 320 saves the workflow for future use by the user. In one implementation, the saving operation 320 also shares the workflow with other users, such as the members of the user's social network, etc.

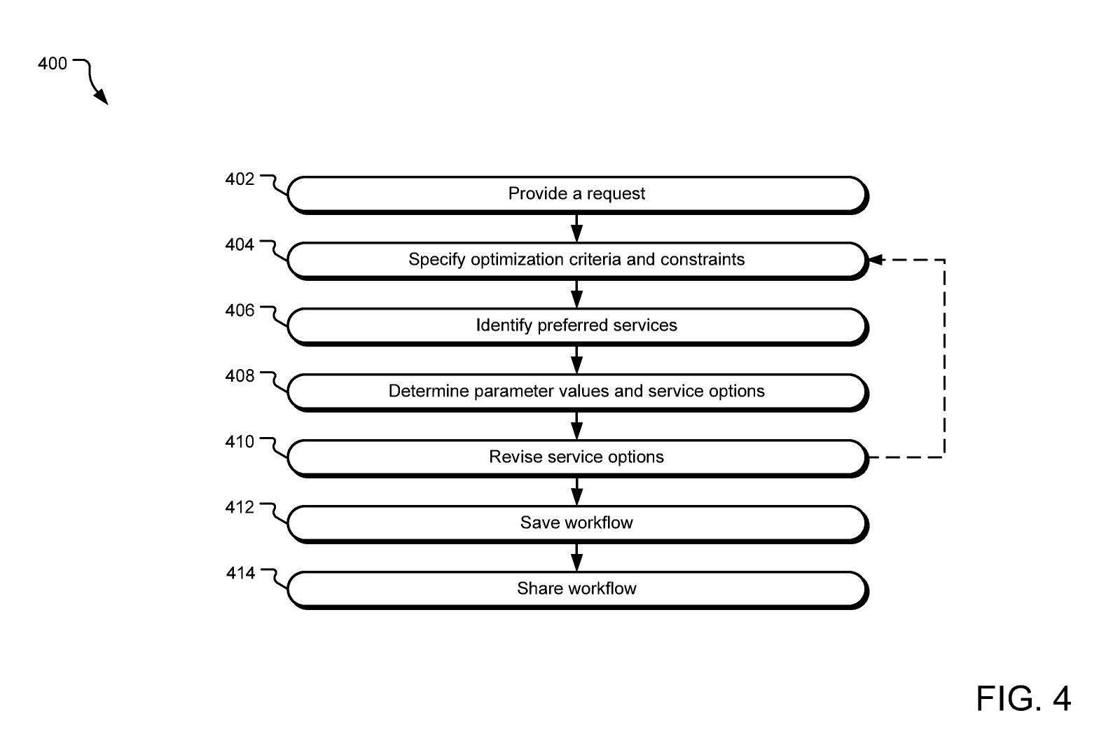

FIG. 4 illustrates example operations 400 for using a personalized workflow. A providing operation 402 provides a request for identifying a task having various task components. An example is a request for the task of shopping for a number of items. A specifying operation 404 provides optimization criteria and constraints related to the shopping request. Thus, an example specifying operation 404 specifies that the total budget for the shopping is four hundred dollars and that all shopping must be done by using no more than two vendors.

An identification operation 406 identifies the preferred services for generating a workflow to complete the specified task. For example, the identification operation 406 identifies using a service by a particular online vendor, such as Amazon® to generate the workflow. Alternatively, no preferred services are provided, in which case a workflow engine will determine which services to use. Subsequently, a determining operation 408 determines parameter values. The determining operation 408 determines such parameter values in response to requests from a workflow engine. Alternatively, a user profile, a user social network, etc., is used to determine the parameter values. The determining operation 408 provides several service options to a user based on the parameter values and the services.

A revising operation 410 revises the service options. Thus, if in response to the request for the task of shopping, a service option is provided for shopping from a first vendor, the revision operation 410 revises the parameters of such a service option. In an alternate example, if a service option provides for buying a pink pair of shoes, the revision operation changes the color of the shoes to red. A workflow engine generates a revised workflow based on the revised service option. In an alternative implementation (shown in the alternative with a dashed arrow line), after revising the service options by the revising operation 410, the control is transferred to the specifying operation 404 to further refine the parameter values and the service options.

Subsequently, a saving operation 412 saves the workflow. In one implementation, the saving operation 412 saves the workflow on a user's mobile device or a smart phone. Alternatively, the saving operation saves the workflow to a server location. A sharing operation 414 shares the workflow as specified by the user. For example, the sharing operation shares the workflow with members of the user's social network.

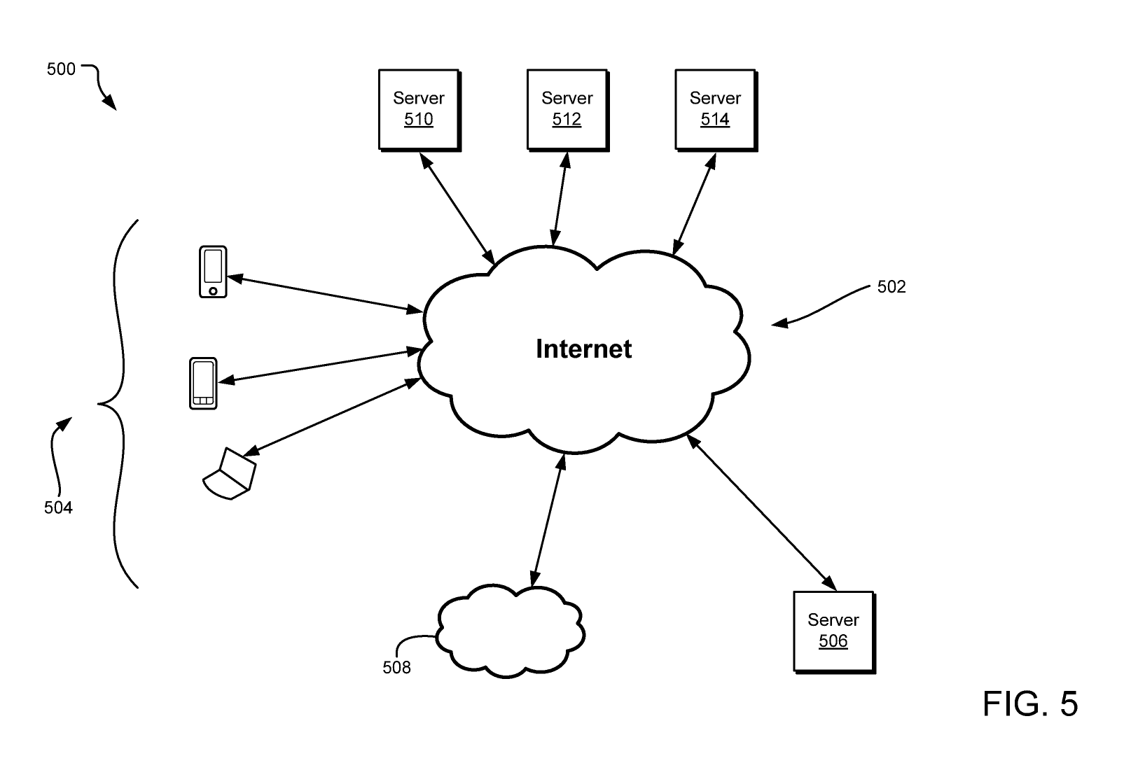

FIG. 5 illustrates an example network environment 500 for implementing the system for authoring and using personalized workflows. Specifically, FIG. 5 illustrates a communications network 502 (e.g., the Internet) that is used by various computing or data storage devices for implementing the system for authoring and using personalized workflows. In one implementation, user devices 504 are communicatively connected to the communications network 502. Examples of the user devices 504 include a personal computer, a laptop, a smart phone, etc. A user interested in authoring and/or using a personalized workflow uses such user devices 504 to access the system for authoring and using personalized workflows.

A server 506 hosts the system for authoring and using personalized workflows. In an alternate implementation, the server 506 also hosts a website or an application that users visit to access the system for authoring and using personalized workflows. Alternatively, a cloud 508 hosts various components of the system for authoring and using personalized workflows. The user devices 504, the server 506, the cloud 508, as well as other resources connected to the communications network 502 access the servers 510, 512, and 514 for getting access to various websites, services, applications, etc., that are used in authoring and using personalized workflows. In one implementation, the server 506 also hosts a search engine that is used by the system for authoring and using personalized workflows to select services used in authoring and using personalized workflows.

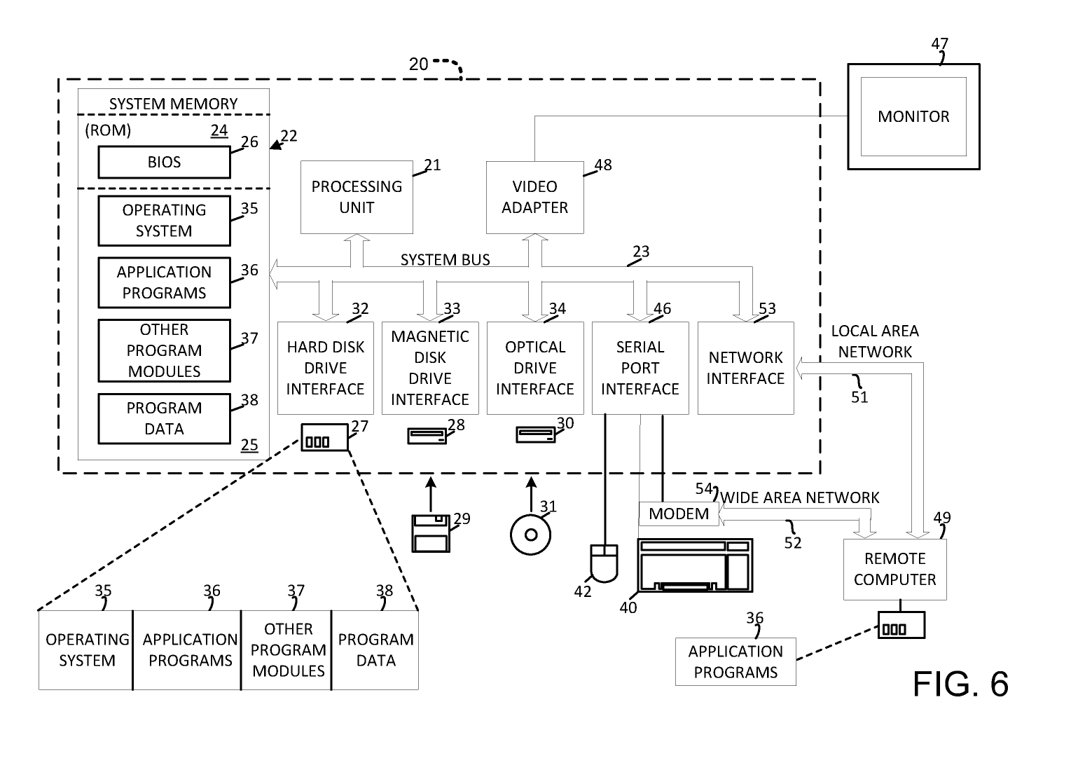

FIG. 6 illustrates an example system that may be useful in implementing the described technology. The example hardware and operating environment of FIG. 6 for implementing the described technology includes a computing device, such as general purpose computing device in the form of a gaming console or computer 20, a mobile telephone, a personal data assistant (PDA), a set top box, or other type of computing device. In the implementation of FIG. 6, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 6. The logical connections depicted in FIG. 6 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of and communications devices for establishing a communications link between the computers may be used.

In an example implementation, a workflow engine, various applications, and other engines and services may be embodied by instructions stored in memory 22 and/or storage devices 29 or 31 and processed by the processing unit 21. A user profile, user requests, information about a user's social network, and other data may be stored in memory 22 and/or storage devices 29 or 31 as persistent datastores. Further, a workflow engine represents hardware and/or software configured to provide service functionality for network-connected systems. Such services may be implemented using a general purpose computer and specialized software (such as a server executing service software), a special purpose computing system and specialized software (such as a mobile device or network appliance executing service software), or other computing configurations.

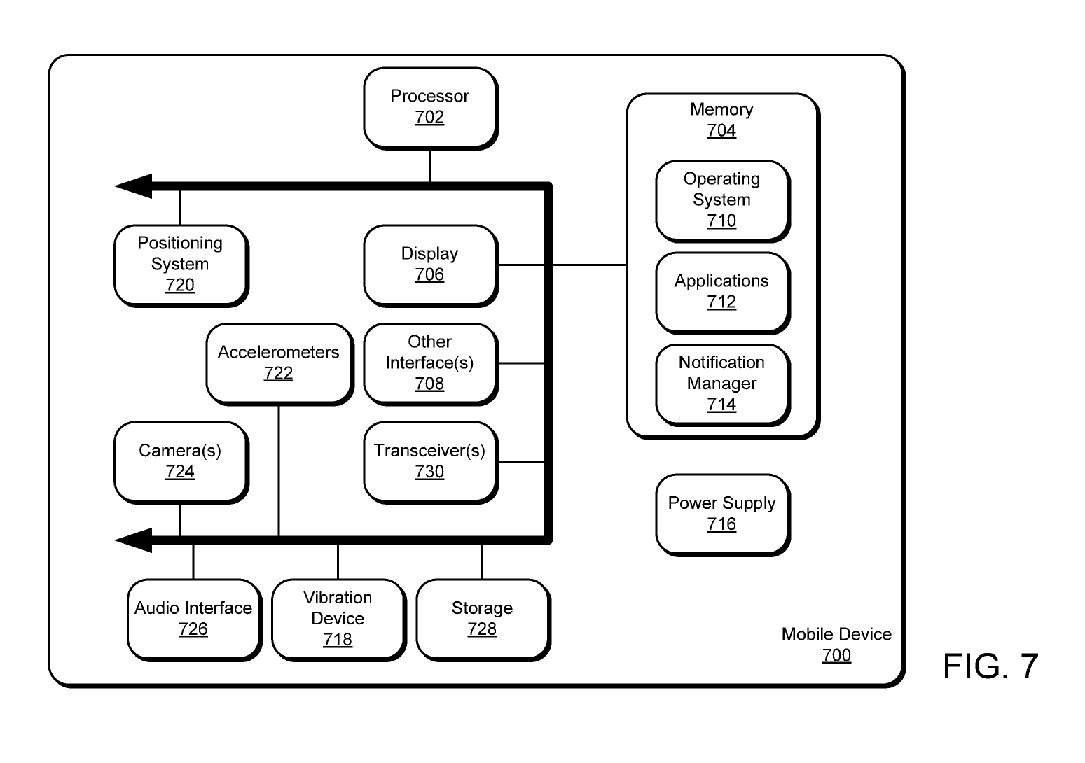

FIG. 7 illustrates another example system (labeled as a mobile device 700) that may be useful in implementing the described technology. The mobile device 700 includes a processor 702, a memory 704, a display 706 (e.g., a touchscreen display), and other interfaces 708 (e.g., a keyboard). The memory 704 generally includes both volatile memory (e.g., RAM) and non-volatile memory (e.g., flash memory). An operating system 710, such as the Microsoft Windows® Phone 7 operating system, resides in the memory 704 and is executed by the processor 702, although it should be understood that other operating systems may be employed.

One or more application programs 712 are loaded in the memory 704 and executed on the operating system 710 by the processor 702. Examples of applications 712 include without limitation email programs, scheduling programs, personal information managers, Internet browsing programs, multimedia player applications, etc. A notification manager 714 is also loaded in the memory 704 and is executed by the processor 702 to present notifications to the user. For example, when a promotion is triggered and presented to the shopper, the notification manager 714 can cause the mobile device 700 to beep or vibrate (via the vibration device 718) and display the promotion on the display 706.

The mobile device 700 includes a power supply 716, which is powered by one or more batteries or other power sources and which provides power to other components of the mobile device 700. The power supply 716 may also be connected to an external power source that overrides or recharges the built-in batteries or other power sources.

The mobile device 700 includes one or more communication transceivers 730 to provide network connectivity (e.g., mobile phone network, Wi-Fi®, BlueTooth®, etc.). The mobile device 700 also includes various other components, such as a positioning system 720 (e.g., a global positioning satellite transceiver), one or more accelerometers 722, one or more cameras 724, an audio interface 726 (e.g., a microphone, an audio amplifier and speaker and/or audio jack), and additional storage 728. Other configurations may also be employed.

In an example implementation, a personalized workflow authoring system, and other modules and services may be embodied by instructions stored in memory 704 and/or storage devices 728 and processed by the processing unit 702. User preferences, service options, and other data may be stored in memory 704 and/or storage devices 728 as persistent datastores.

The embodiments of the invention described herein are implemented as logical steps in one or more computer systems. The logical operations of the present invention are implemented (1) as a sequence of processor-implemented steps executing in one or more computer systems and (2) as interconnected machine or circuit engines within one or more computer systems. The implementation is a matter of choice, dependent on the performance requirements of the computer system implementing the invention. Accordingly, the logical operations making up the embodiments of the invention described herein are referred to variously as operations, steps, objects, or engines. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in another embodiment without departing from the recited claims.

What is claimed:

1. A method comprising:
selecting a plurality of processor-executable services, each of the plurality of processor-executable services related to a task component of a user request;
mapping one or more relationships between parameters of one of the services and parameters of another of the services;
determining parameter values of the parameters, the parameter values satisfying the one or more relationships; and
generating a processor-executable workflow including one or more service options for the task using the parameter values.

2. The method of claim 1, further comprising receiving one or more selection inputs from the user related to the one or more service options.

3. The method of claim 2, wherein receiving one or more selection inputs from the user comprises receiving a first parameter value related to one task component from a first service option and receiving a second parameter value related to another task component from a second service option.

4. The method of claim 2, further comprising providing an option for including an additional task component in the workflow, wherein the additional task component is dependent on the one or more selection inputs from the user..

5. The method of claim 1, wherein mapping the one or more relationships between the parameters comprises mapping a joint constraint on the one or more parameters.

6. The method of claim 1, wherein mapping the one or more relationships comprises normalizing the parameters across the services.

7. The method of claim 1, wherein mapping the one or more relationships comprises mapping dependencies between the parameters of the one of the services and the one or more identified parameters of the another of the services.

8. The method of claim 1, wherein the user request identifies an optimization criterion related to the task and a constraint related to the task.

9. The method of claim 8, wherein determining parameter values of the parameters comprises determining parameter values of the parameters subject to the optimization criterion.

10. The method of claim 8, wherein determining parameter values of the parameters comprises determining parameter values of the parameters subject to the constraint.

11. The method of claim 1, wherein determining parameter values of the parameters comprises determining at least one parameter value based on a personal profile of the user.

12. The method of claim 11, wherein determining parameter values of the parameters comprises at least one of (1) determining at least one parameter value based on a social network of the user and (2) determining at least one parameter value based on past behavior of the user.

13. One or more tangible computer-readable storage media storing computer executable instructions for performing a computer process on a computing system, the computer process comprising:
selecting a plurality of processor-executable services, each of the plurality of processor-executable services related to a task component of the user request;
mapping one or more relationships between parameters of one of the services and parameters of another of the services;
determining parameter values of the parameters, the parameter values satisfying the one or more relationships; and
generating a processor-executable workflow based on the parameter values.

14. The one or more tangible computer-readable storage media of claim 13, wherein the computer process further comprising generating one or more service options based on the workflow.

15. The one or more tangible computer-readable storage media of claim 13, wherein determining parameter values of the parameters comprises determining values of the parameters to satisfy an optimization criterion and a constraint.

16. The one or more tangible computer-readable storage media of claim 13, wherein selecting the plurality of services further comprising selecting the plurality of services based on a user preference.

17. The one or more tangible computer-readable storage media of claim 13, wherein mapping the one or more relationships between the parameters comprises mapping one or more dependencies between the parameters.

18. The one or more tangible computer-readable storage media of claim 17, wherein determining parameter values of the parameters further comprises iteratively determining parameter values of the parameters based on the one or more dependencies between the parameters.

19. A mobile device comprising:
a selection engine configured to select a plurality of services, each of the plurality of services related to a task component of a user request;
a mapping engine configured to map one or more relationships between parameters of one of the services and parameters of another of the services;
a determination engine configured to determine parameter values of the parameters, the parameter values satisfying the one or more relationships;
a presentation engine configured to present a workflow including one or more service options to the user via a mobile device graphical user interface, the one or more service options using the parameter values;
an input engine configured to receive revised parameter values from the user via the mobile device;
an update engine configured to update the workflow based on the revised parameter values; and
an execution engine configured to execute the updated workflow.

20. The mobile device of claim 19, wherein the selection engine is further configured to select the plurality of services based on one or more parameters related to a user profile.
